(19) United States
(12) Patent Application Publication
(10) Pub. No.: US 2017/0282788 A1
(43) Pub. Date: Oct. 5, 2017

(54) ALARM DEVICE AND ALARM SYSTEM USING THE SAME

(71) Applicant: HON HAI PRECISION INDUSTRY CO., LTD., New Taipei (TW)

(72) Inventors: CHUANG-WEI TSENG, New Taipei (TW); KAI-FU CHEN, New Taipei (TW); CHIA-YUN LEE, New Taipei (TW); YU-CHING CHIEN, New Taipei (TW); HUNG-CHUN LU, New Taipei (TW)

(21) Appl. No.: 15/170,957

(22) Filed: Jun. 2, 2016

(30) Foreign Application Priority Data
Apr. 1, 2016 (TW) 105110455

(51) Int. Cl. B60Q 1/52; B60Q 5/00

(52) U.S. Cl. CPC B60Q 1/52; B60Q 5/001

(57) ABSTRACT

A road traffic alarm and warning device, moveably mounted to an enclosure of a car and configured to notify a traffic obstacle and coupled to a main controller, includes a first communication unit configured to couple to the main controller and send out a control signal. An operation unit is configured to receive the control signal and output a driving signal according to the control signal and a driving unit is configured to receive the driving signal and move as required driving the alarm device to move out of the enclosure and into action. An alarm system with the alarm device is further disclosed.

### FIELD

The subject matter herein generally relates to traffic safety and an alarm system with the alarm device.

### BACKGROUND

An alarm device can be a tripod in a car. When an accident occurs, a warning tripod should be placed at a safe distance.

### BRIEF DESCRIPTION OF THE DRAWINGS

Implementations of the present technology will now be described, by way of example only, with reference to the attached figures.

FIG. 1 is a block diagram of an embodiment of an alarm system with an alarm device.

FIG. 2 is a schematic diagram of the alarm device of FIG. 1.

FIG. 3 is a block diagram of the alarm device and a main controller of the alarm system of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising,” when utilized, means “including, but not necessarily limited to”; it specifically indicates open-ended inclusion or membership in the so-described combination, group, series, and the like.

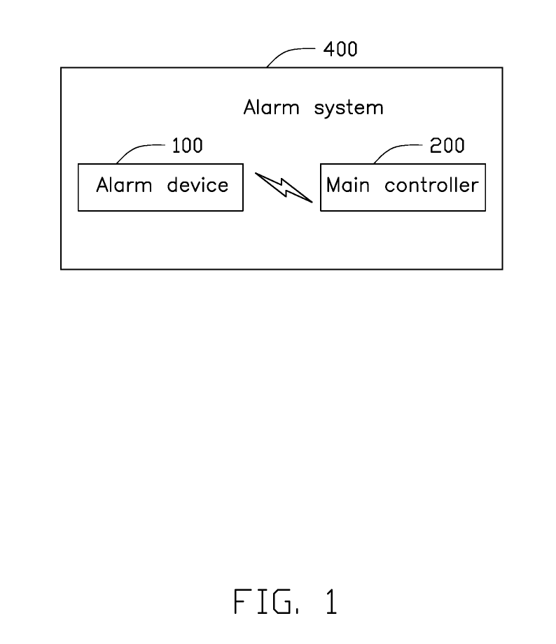

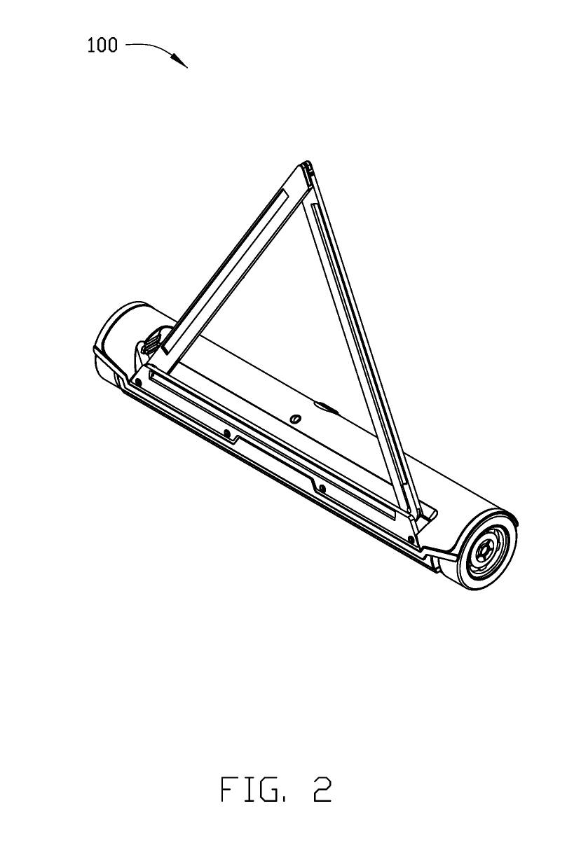

FIG. 1 and FIG. 2 illustrate a traffic alarm system 400 in an embodiment. The alarm system 400 can include an alarm device 100 and a main controller 200. The main controller 200 is wirelessly coupled to the alarm device 100. In an embodiment, the alarm device 100 is a tripod, and the main controller 200 is a mobile phone.

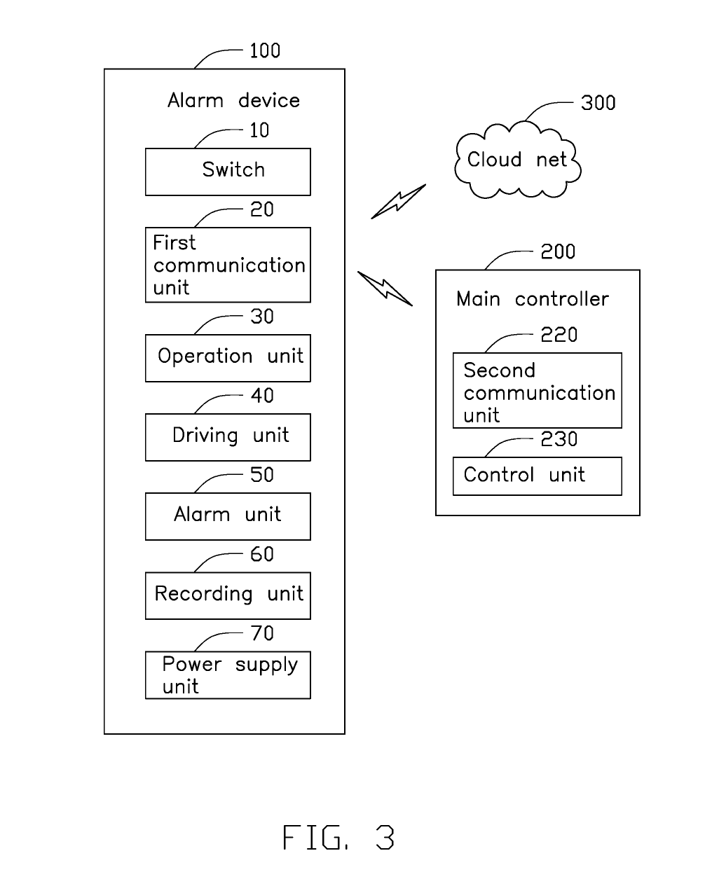

FIG. 3 illustrates that the alarm device 100 can include a switch 10, a first communication unit 20, an operation unit 30, a driving unit 40, an alarm unit 50, a recording unit 60, and a power supply unit 70.

The switch 10 is configured to enable the alarm device 100. When the switch 10 is switched on, the alarm device 100 is activated.

The first communication unit 20 is coupled to the main controller 200. The main controller 200 is configured to control the first communication unit 20 to send a control signal to the operation unit 30.

The first communication unit 20 is further coupled to a cloud net 300, which has a guiding system, such as a guide map. When the switch 10 is switched on, the first communication unit 20 send a global positioning system (GPS) information to the guiding system. The guiding system receives the GPS information and notifies location information to other drivers, so that other drivers can change direction in time.

The operation unit 30 is configured to output a driving single to the driving unit 40 according to the control signal.

The driving unit 40 is configured to receive the driving signal and drive the alarm device 100 to move according to the driving signal.

The alarm unit 50 is configured to output alarm to warn that a traffic obstacle has occurred. In at least one embodiment, the alarm signal is a squealing sound or flashing lights.

The recording unit 60 is configured to record multimedia data of the location, where the traffic obstacle is. The recording unit 60 can include a camera and a microphone. When the switch 10 is switched on, the recording unit 60 records multimedia data and sends the multimedia data to the main controller 200 via the first communication unit 20. In other embodiment, the recording unit 60 sends the multimedia data to any electronic device coupled to the first communication unit 20.

The power supply unit 70 is configured to supply power to the first communication unit 20, the operation unit 30, the driving unit 40, the alarm unit 50, and the recording unit 60. The power supply unit 70 supplies power wirelessly or through wires.

The main controller 200 can include a second communication unit 220 and a control unit 230.

The second communication unit 220 is configured to communicate with the first communication unit 20. In at least one embodiment, each of the second communication unit 220 and the first communication unit 20 is a BLUETOOTH module.

The control unit 230 can include a plurality of direction buttons (not shown) configured to control the alarm device 100 to move accordingly.

For example, when a front button of the control unit 230 is pressed, the control unit 230 outputs a first control signal to the second communication unit 220, the first communication unit 20 outputs a first communication result to the operation unit 30, the operation unit 30 outputs a first driving signal to the driving unit 40, and the driving unit 40 drives the alarm device 100 to move forward according to the first driving signal.

When a back button of the control unit 230 is pressed, the control unit 230 outputs a second control signal to the second communication unit 220, the first communication unit 20 outputs a second communication result to the operation unit 30, the operation unit 30 outputs a second driving signal to the driving unit 40, and the driving unit 40 drives the alarm device 100 to move back according to the second driving signal.

Thus, the alarm device 100 can automatically be moved to a safe distance to warn other drivers when a road obstacle is present, by the main controller 200.

When needed, the switched 10 is switched on, the alarm device 100 is moved automatically, the control unit 230 can control the alarm device 100 to move to a suitable location. The first communication unit 20 sends a local GPS information to the guiding system to notify other drivers. The alarm unit 50 also outputs alarm. The recording unit 60 records multimedia data of the accident.

The embodiments shown and described above are only examples. Many details are often found in the art such as the other features of a alarm device. Therefore, many such details are neither shown nor described. Even though numerous characteristics and advantages of the present technology have been set forth in the foregoing description, together with details of the structure and function of the present disclosure, the disclosure is illustrative only, and changes may be made in the details, including in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. An alarm device, moveably mounted to an enclosure of a car and configured to notify a traffic accident and coupled to a main controller, comprising:
a first communication unit configured to couple to the main controller and send out a control signal;
an operation unit configured to receive the control signal and output a driving signal according to the control signal;
a driving unit configured to receiving the driving signal and move accordingly, driving the alarm device to move out of the enclosure.

2. The alarm device of claim 1, further comprising a recording unit configured to record multimedia data of the traffic accident, wherein the recording unit comprises a camera and a microphone.

3. The alarm device of claim 2, further comprising an alarm unit, wherein the alarm unit is configured to output an alarm signal to notify of the traffic accident.

4. The alarm device of claim 3, wherein the alarm signal is squealing.

5. The alarm device of claim 3, wherein the alarm signal is twinkling light.

6. The alarm device of claim 3, wherein the first communication unit is coupled to a cloud net, which has a guided system, the first communication unit is configured to send a location information to the guided system, and the guided system is configured to notify of the traffic accident at the location to users of the cloud net.

7. The alarm device of claim 3, further comprising a power supply unit configured to supply power to the first communication unit, the operation unit, the driving unit, the alarm unit, and the recording unit.

8. An alarm system comprising
a main controller;
an alarm device moveably mounted to an enclosure of a car and configured to notify a traffic accident and coupled to the main controller, comprising:
a first communication unit configured to couple to the main controller and send out a control signal;
an operation unit configured to receive the control signal and output a driving signal according to the control signal;
a driving unit configured to receiving the driving signal and move accordingly, driving the alarm device to move out of the enclosure.

9. The alarm system of claim 8, wherein the alarm device further comprises a recording unit configured to record multimedia data of the traffic accident, and the recording unit comprises a camera and a microphone.

10. The alarm system of claim 9, further comprising an alarm unit, wherein the alarm unit is configured to output an alarm signal to notify the traffic accident.

11. The alarm system of claim 10, wherein the alarm signal is squealing.

12. The alarm system of claim 10, wherein the alarm signal is twinkling light.

13. The alarm system of claim 10, wherein the first communication unit is coupled to a cloud net, which has a guided system, the first communication unit is configured to send a location information to the guided system, and the guided system is configured to notify the traffic accident at the location to users of the cloud net.

14. The alarm system of claim 10, further comprising a power supply unit configured to supply power to the first communication unit, the operation unit, the driving unit, the alarm unit, and the recording unit.

15. The alarm system of claim 8, wherein the main device is a mobile phone.

16. The alarm system of claim 8, wherein the main device comprises a second communication unit coupled to the first communication unit and a control unit, the control unit comprises a plurality of direction buttons, which configured to control the driving unit to move according to the directions.
